(19) United States
(12) Patent Application Publication
(10) Pub. No.: US 2022/0386364 A1
(43) Pub. Date: Dec. 1, 2022

(54) METHOD AND APPARATUS FOR GRANT-FREE UPLINK COMMUNICATION

(71) Applicant: ZEKU, INC., Palo Alto, CA (US)

(72) Inventors: Su-Lin LOW, San Diego, CA (US); Tianan MA, San Diego, CA (US); Hong Kui YANG, San Diego, CA (US); Hausting HONG, San Diego, CA (US); Chun-I LEE, San Diego, CA (US)

(21) Appl. No.: 17/884,253

(22) Filed: Aug. 9, 2022

Related U.S. Application Data
(63) Continuation of application No. PCT/US2021/014236, filed on Jan. 20, 2021.
(60) Provisional application No. 62/978,707, filed on Feb. 19, 2020.

(51) Int. Cl. H04W 72/14

(52) U.S. Cl. CPC H04W 72/14

(57) ABSTRACT

Embodiments of apparatuses and methods for grant-free uplink communication may be applicable to communication systems, such as wireless communication systems. In an example, a method for grant-free uplink communication can include requesting, by a user equipment, a plurality of instances of configured grants, each with at least one of a specific resource level, repetition, or period. The method can also include receiving, at the user equipment, a pre-allocation of the requested plurality of instances of the configured grants at the at least one of the specific resource level, repetition, or period. The method can further include transmitting, by the user equipment, data according to the pre-allocation. In some examples, the transmitting the data can include transmitting at varying data rates up to a level provided by the pre-allocation, depending on user equipment needs.

### CROSS-REFERENCE TO RELATED APPLICATIONS

This application is a continuation of International Application No. PCT/US2021/014236, filed on Jan. 20, 2021, which claims the benefit of priority to U.S. Provisional Application No. 62/978,707 filed on Feb. 19, 2020, the contents of which are incorporated herein by reference in their entireties.

### BACKGROUND

Embodiments of the present disclosure relate to apparatuses and methods for grant-free uplink communication, which may be applicable to communication systems, such as wireless communication systems.

In wireless communication systems, applications in each user equipment may generate data packets for transmission. The user equipment can communicate the data packets according to a schedule set by a network element, such as a base station, access point, or the like.

### SUMMARY

Embodiments of apparatuses and methods for grant-free uplink communication are disclosed herein. The apparatuses may be variously implemented as user equipment, systems-on-chip, or the components or sub-components, such as the protocol stack thereof.

For example, a method for grant-free uplink communication can include requesting, by a user equipment, a plurality of instances of configured grants, each with at least one of a specific resource level, repetition, or period. The method can also include receiving, at the user equipment, a pre-allocation of the requested plurality of instances of the configured grants at the at least one of the specific resource level, repetition, or period. The method can further include transmitting, by the user equipment, data according to the pre-allocation. In some embodiments, the transmitting the data can include transmitting at varying data rates up to a level provided by the pre-allocation, depending on user equipment needs.

For another example, a method for control of grant-free uplink communication can include receiving a request from a user equipment for a plurality of instances of configured grants, each with at least one of a specific resource level, repetition, or period. The method can also include pre-allocating to the user equipment the requested plurality of instances of the configured grants at the at least one of the specific resource level, repetition, or period. The method can further include receiving subsequently transmitted data from the user equipment according to the pre-allocation. In some embodiments, the data can be transmitted from the user equipment at varying data rates up to a level provided by the pre-allocation, depending on user equipment needs.

For a further example, an apparatus for grant-free uplink communication, such as user equipment, can include at least one processor and at least one memory having computer program instructions. The memory and the computer program instructions can be configured to, with the at least one processor, cause the apparatus at least to request a plurality of instances of configured grants, each with at least one of a specific resource level, repetition, or period. The memory and the computer program instructions can also be configured to, with the at least one processor, cause the apparatus at least to receive a pre-allocation of the requested plurality of instances of the configured grants at the at least one of the specific resource level, repetition, or period. The memory and the computer program instructions can also be configured to, with the at least one processor, cause the apparatus at least to transmit data according to the pre-allocation. In some embodiments, the transmitting the data can include transmitting at varying data rates up to a level provided by the pre-allocation, depending on user equipment needs.

For yet another example, an apparatus for control of grant-free uplink communication, such as a base station or access point, can include at least one processor and at least one memory having computer program instructions. The memory and the computer program instructions can be configured to, with the at least one processor, cause the apparatus at least to receive a request from a user equipment for a plurality of instances of configured grants, each with at least one of a specific resource level, repetition, or period. The memory and the computer program instructions can also be configured to, with the at least one processor, cause the apparatus at least to pre_allocate to the user equipment the requested plurality of instances of the configured grants at the at least one of the specific resource level, repetition, or period. The memory and the computer program instructions can further be configured to, with the at least one processor, cause the apparatus at least to receive subsequently transmitted data from the user equipment according to the pre-allocation. In some embodiments, the data can be transmitted from the user equipment at varying data rates up to a level provided by the pre-allocation, depending on user equipment needs.

For still another example, a non-transitory computer-readable medium can be encoded with instructions that, when executed in hardware, perform a method for grant-free uplink communication. The method can include requesting, by a user equipment, a plurality of instances of configured grants, each with at least one of a specific resource level, repetition, or period. The method can also include receiving, at the user equipment, a pre-allocation of the requested plurality of instances of the configured grants at the at least one of the specific resource level, repetition, or period. The method can additionally include transmitting, by the user equipment, data according to the pre-allocation. In some embodiments, the transmitting the data can include transmitting at varying data rates up to a level provided by the pre-allocation, depending on user equipment needs.

For a still further example, a non-transitory computer-readable medium can be encoded with instructions that, when executed in hardware, perform a method for control of grant-free uplink communication. The method can include receiving a request from a user equipment for a plurality of instances of configured grants, each with at least one of a specific resource level, repetition, or period. The method can also include pre-allocating to the user equipment the requested plurality of instances of the configured grants at the at least one of the specific resource level, repetition, or period. The method can further include receiving subsequently transmitted data from the user equipment according to the pre-allocation. In some embodiments, the data can be transmitted from the user equipment at varying data rates up to a level provided by the pre-allocation, depending on user equipment needs.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a fifth-generation new radio uplink medium access control transmission using dynamic grant allocation.

FIG. 2 illustrates fifth-generation new radio uplink medium access control transmissions using dynamic grant allocation.

FIG. 3 illustrates an adaptable uplink medium access control scheme for fast, grant-free, low-latency data transmission, according to certain embodiments of the present disclosure.

FIG. 4 illustrates another example of an adaptable uplink medium access control scheme for fast, grant-free, low-latency data transmission, according to certain embodiments of the present disclosure.

FIG. 5 illustrates a signal flow diagram of a method according to certain embodiments of the present disclosure.

FIG. 6 illustrates a method according to certain embodiments of the present disclosure.

FIG. 7 illustrates a block diagram of an apparatus including a baseband chip, a radio frequency (RF) chip, and a host chip, in which some aspects of the present disclosure may be implemented, according to certain embodiments of the present disclosure.

FIG. 8 illustrates an exemplary wireless network that may incorporate grant-free uplink communication, in which some aspects of the present disclosure may be implemented, according to certain embodiments of the present disclosure.

FIG. 9 illustrates a node that may implement grant-free uplink communication or control thereof, according to certain embodiments of the present disclosure.

### DETAILED DESCRIPTION

Although specific configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of wireless communication systems will now be described with reference to various apparatus and methods. These apparatus and methods will be described in the following detailed description and illustrated in the accompanying drawings by various blocks, modules, units, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various wireless communication networks, such as code division multiple access (CDMA) system, time division multiple access (TDMA) system, frequency division multiple access (FDMA) system, orthogonal frequency division multiple access (OFDMA) system, single-carrier frequency division multiple access (SC-FDMA) system, and other networks. The terms “network” and “system” are often used interchangeably. A CDMA network may implement a radio access technology (RAT) such as Universal Terrestrial Radio Access (UTRA) and CDMA 2000, etc. A TDMA network may implement a RAT such as the Global System for Mobile Communications (GSM). An OFDMA network may implement a RAT, such as long term evolution (LTE) or new radio (NR). The techniques and systems described herein may be used for the wireless networks and RATs mentioned above, as well as other wireless networks and RATs. Likewise, the techniques and systems described herein may also be applied to wired networks, such as networks based on optical fibers, coaxial cables, or twisted-pairs, or to satellite networks.

According to existing standards, a user equipment (UE) can be pre-configured with one single configured grant configuration with a specific period interval, and one specific resource allocation in time and frequency. Additionally, the network can pre-allocate proactive grants for the user equipment, either constantly or in periodic intervals. For example, in a Fifth-Generation (5G) cellular wireless modem, the user equipment can transmit uplink data packets through resource allocations scheduled by the Network/Base Station.

In a dynamic allocation, the UE sends scheduling requests (SRs) at specific SR periodic transmission occasions on the physical uplink (UL) control channel (PUCCH) to the network. The network then runs an uplink scheduling algorithm to allocate resources for the user equipment through downlink (DL) physical downlink control channel (PDCCH) downlink control indicator (DCI) information. This UL grant may arrive only after several SR requests from the user equipment. The user equipment may re-send an SR request several times at allowed time intervals, and only at periodic PUCCH SR transmission opportunities. The UL grant schedules the transmission of the data on the PUSCH for the UE. As a result, there may be a long delay from the time when the packet data arrives at the modem L2 buffer, to the time when the data packets are prepared and transmitted on the physical uplink shared channel (PUSCH).

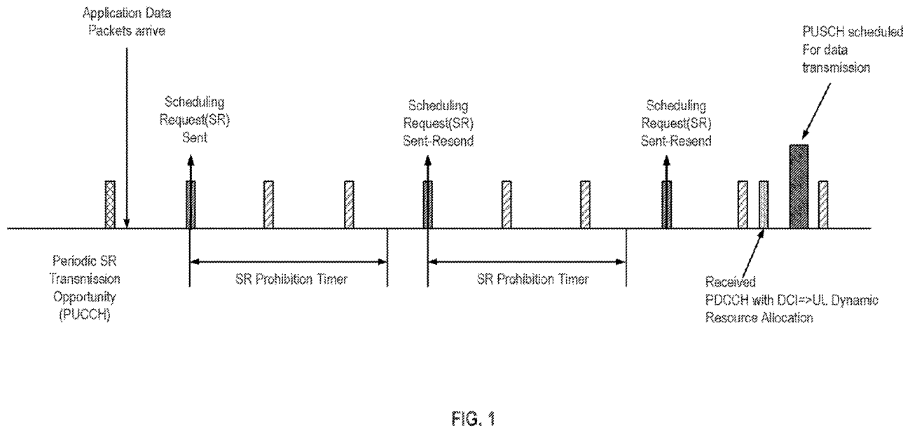

FIG. 1 illustrates a fifth-generation new radio uplink medium access control transmission using dynamic grant allocation. As shown in FIG. 1, after a periodic scheduling request transmission opportunity on the physical uplink control channel, application data packets may arrive. Accordingly, a user equipment may send a first scheduling request at a first subsequent opportunity. The user equipment may then be in a scheduling request prohibition timer for a period of time and consequently may not be able to send another scheduling request during that period. Once the timer has expired, the user equipment may re-send the scheduling request. Again, the user equipment may be in a scheduling request prohibition timer and consequently may miss additional scheduling request opportunities. Finally, the user equipment may again re-send the scheduling request and may, during the prohibition timer, receive a grant via PDCCH DCI with an uplink dynamic resource allocation. Accordingly, the user equipment can then send the application data packets during the PUSCH scheduled for data transmission.

For delay-sensitive low latency applications including URLLC, such a dynamic allocation scheme may not work. Instead, a pre-configured periodic grant-free scheme may be employed. Here, the network may pre-allocate UL grant opportunities at a fixed resource allocation level at a fixed periodic interval pattern. Hence there may be a minimal delay between the arrival of a data packet and the UL transmission time: the user equipment may just need to wait for the upcoming periodic transmission opportunity.

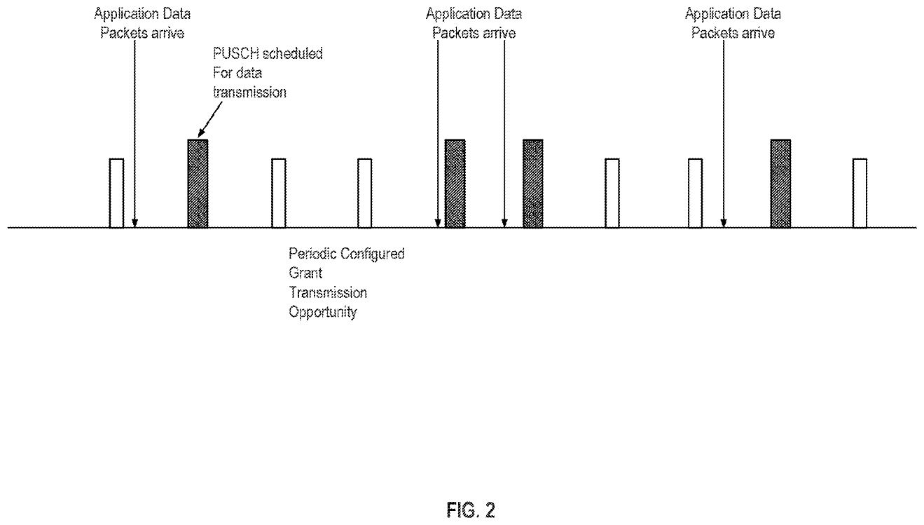

FIG. 2 illustrates fifth-generation (5G) new radio (NR) uplink medium access control transmissions using dynamic grant allocation. As shown in FIG. 2, at various times, application data packets can arrive. Meanwhile, there can be a single periodic configured grant transmission opportunity. Thus, the application data packets that have arrived can be served at the next occasion of the periodic configured grant transmission opportunity. If there are no packets to be transmitted, the occasion can simply remain unused.

These approaches may result in inefficient resource allocation for one level of resource, regardless of user equipment data needs. Likewise, these approaches may result in inflexible resource allocation for only one type of traffic and application. Furthermore, these approaches may result in increased power due to fixed pre-allocated resource level and wastage of network resources for specific UEs. These approaches may also lack the ability to multiplex different applications with varying data rate needs.

A challenge in uplink medium access control (MAC) transmission is the scheduling delay in dynamic allocation, where the user equipment requests uplink resource allocation according to the UE's data buffer needs, and waits for the network scheduler to allocate specific resources to the user equipment according to network (NW) conditions and other user equipment needs. For low latency applications such as Ultra Reliable Low Latency Communication (URLLC), a minimum delay fast scheduling scheme is required, which needs to be able to adapt to different traffic types.

Certain embodiments of the present disclosure provide a 5G uplink MAC layer method for adaptable, fast grant-free data transmission for low latency applications such as URLLC. This method may allow the user equipment to request multiple instances of configured grants, each with a specific resource level, repetitions, and periods. The network can pre-allocate these grants at the requested resource levels. The user equipment can subsequently transmit data at varying data rates up to the pre-allocated level as and when the user equipment has data to send, minimizing scheduling and data transmission delays.

Certain embodiments may relate to requesting and allocating multiple instances of grant-free configured grant uplink transmissions. For example, in certain embodiments, the user equipment can request the network to set up a plurality, N, of instances of configured grant configurations. Each of the configured grants can be for a different logical channel (LC) or group of LCs with specific periodic traffic pattern, repeat level, resource level, and latency. This aspect of certain embodiments may allow a user equipment to multiplex concurrent Low Latency applications with different traffic requirement needs, with grant-free scheduling on the configured grant resource allocations. This can be used for URLLC applications.

Certain embodiments may relate to requesting and allocating a plurality, M, of discrete resource allocation levels for each grant-free transmission. In certain embodiments, the user equipment can request the network to allocate a pre-defined resource level according to the UE's own estimated nominal traffic needs. The network can pre-configure a resource allocation configuration (with time and frequency allocations) from each discrete M resource level grant size. This pre-configuration methodology may eliminate unnecessary scheduling delay from dynamic allocation, such that the user equipment can prepare an exact grant size for each transmission, as and when the user equipment has (or expects to have) data to send.

Certain embodiments may relate to dynamic adaptation of resource levels for each grant-free repetition. For each grant-free configuration, a list of resource levels up to the maximum requested resource level may be configured. The user equipment can then dynamically indicate a varying reduced level if the data to send is different in each periodic transmission. This approach can reduce user equipment transmit power and consequently also reduce interference presented to other UEs. The network can also reuse the unused resource for other UEs' dynamic allocation needs.

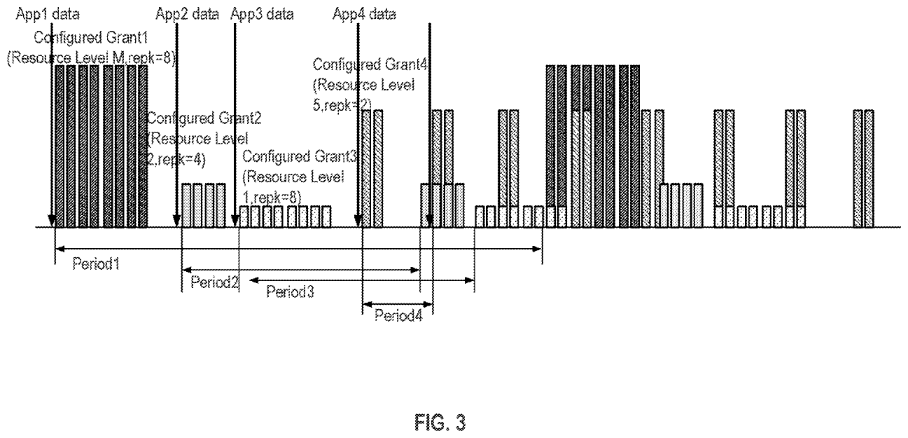

FIG. 3 illustrates an adaptable uplink medium access control scheme for fast, grant-free, low-latency data transmission, according to certain embodiments of the present disclosure. The example of FIG. 3 is simply one example of such an adaptable uplink medium access control scheme for fast, grant-free, low-latency data transmission, while numerous variations thereupon are permitted.

During connection setup, the user equipment may request the network to setup up to N multiple instances of configured grant configurations. In FIG. 3, N is 4, as there are four distinct configured grants, respectively Configured Grant 1, Configured Grant 2, Configured Grant 3, and Configured Grant 4.

Each of the N configurations can be associated with a Logical Channel (LC), or a group of LCs with a specific traffic pattern and latency requirement. These requirements may include a specific level of repeats, which ensure the reliable delivery of the low latency data packets. The example in FIG. 3 shows 4 different applications that are configured with different periodic transmissions, each with a different number of repeats, and each with a requested maximum discrete level of resource allocation. In this example, Configured Grant 1 has a resource level of M (the maximum level) and 8 repetitions, with a long period, Period 1. Configured Grant 2 has a resource level 2 and 4 repetitions, with Period 2, which is shorter than Period 1. Configured Grant 3 has a resource level of 1 and 8 repetitions, with Period 3, which is about the same as Period 2. Finally, Configured Grant 4 has a resource level of 5 with two repetitions and Period 4, which is the shortest of the periods in this example.

The user equipment UE can first request the network to allocate a required resource level according to the UE's maximum anticipated periodic traffic needs at each of the periodic transmission occasion(s), up to any one of the specified M discrete levels. This requested level (which could be designated as level K) can correspond to specific grant size bits, which both the user equipment and the network can be pre-configured in the user equipment's initial settings.

The user equipment can send to the network a list of configured grant requests, up to N instances, each corresponding to an application (or group of applications): Configured Grant Request List [N], where each request can include Configured Grant Request: (UE to NW) {Period, RepK (repetition level), and Resource Request Level K (from Level 1 to M)}. The network can then pre-allocate this requested Level K. The grant size can be encoded with bits in terms of resource allocation structure list with a specific time and frequency resource allocation.

The network sends the user equipment a list of configured grant configurations, up to N instances: Configured Grant Configuration List [N], where each configuration instance can include Configured Grant Configuration: (NW to UE) {Period, RepK (repetition level), Transmit parameters, Resource Allocation List [K] {resource allocation— (time, frequency), MCS} }.

The resource allocation list structure can contain a list of K resource allocations in terms of time and frequency according to the NW's serving cell configuration, as well as a corresponding Modulation and Coding Scheme (MCS) index for each resource allocation level. This will be a list in discrete levels from Level 1 to Level K. Network will however, only pre-allocate up to the requested level K.

When the UE's application has data to send at a specific time, the user equipment can immediately compose a MAC packet data unit (MACPDU) with the exact grant size according to the pre-allocated configuration at the specific transmit time, eliminating any scheduling request or further communications delay with the network. This approach may allow the user equipment to multiplex its concurrent real-time low latency applications with different traffic requirement needs, with grant-free scheduling on the configured grant resource allocations.

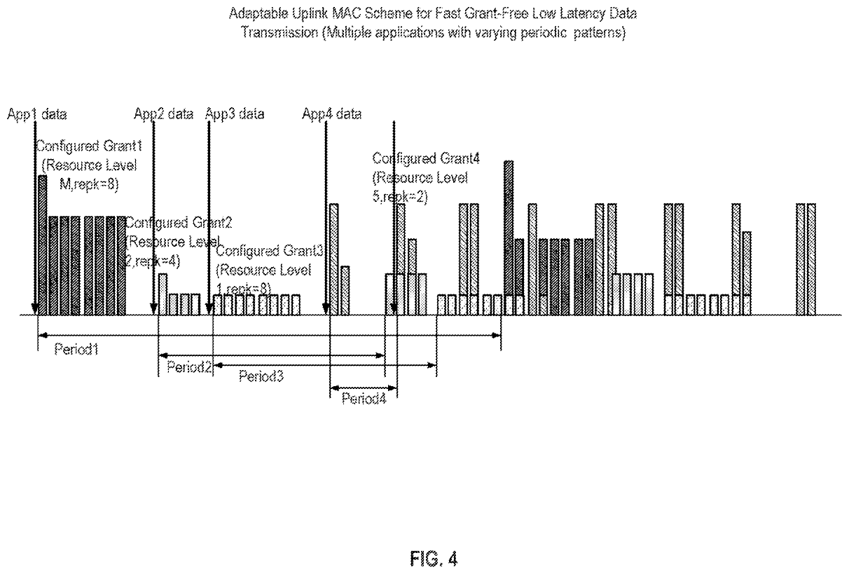

FIG. 4 illustrates another example of an adaptable uplink medium access control scheme for fast, grant-free, low-latency data transmission, according to certain embodiments of the present disclosure. One difference between the example of FIG. 3 and FIG. 4, is that in FIG. 3 the applications have a consistent pattern, whereas the applications in FIG. 4 have varying patterns.

Certain embodiments may allow the user equipment to adjust the user equipment's transmission scheme with varying periodic traffic pattern, as and when the user equipment is transmitting.

As shown in FIG. 4, when the user equipment has data to send for a specific application with a pre-configured resource allocation, the user equipment can select a discrete level of resource corresponding to the user equipment's current data buffer queue and data rate. These levels can be pre-configured at the network according to the configured grant configuration's resource allocation list[K] that it sends to the UE during setup.

The user equipment can then prepare a MACPDU with the selected exact grant size, and can signal to the network, using a configured grant MAC CE, the specific resource allocation level that the user equipment selected to use corresponding to the uplink data rate. This MAC CE can be included at the end of the data MacSubPDUs, where the UE can indicate a 4-bit resource level that it is transmitting: Configured Grant MAC CE {Resource Allocation Level}.

In essence, the user equipment can transmit grant-free low latency packets with varying data rates at periodic intervals according to the user equipment's data buffer status, and can feed back each data rate in real-time when the user equipment is transmitting.

Since the network will not know the reduced data rate at the first slot of transmission in a repeat bundle, the network can still pre-allocate the maximum requested resource for this first slot. After the network decodes the MAC CE, the network can pre-allocate the reduced level of resource for subsequent UL transmissions in the repeated slots.

The method can reduce the user equipment transmit power, which can cause less interference level to other UEs. The network can then reuse the unused resource for other UE's dynamic allocation needs.

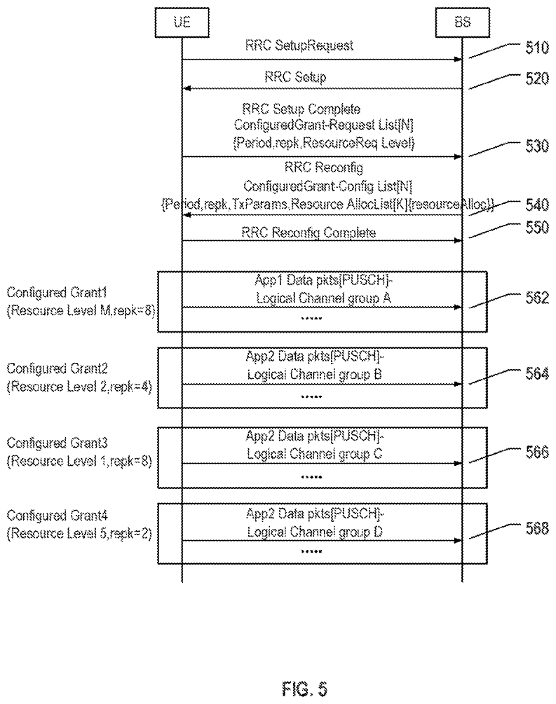

FIG. 5 illustrates a signal flow diagram of a method according to certain embodiments. As shown in FIG. 5, at 510, the user equipment can send an RRC setup request for a connection setup (or alternatively, not shown, the UE can send an RRC resume or an RRC re-establishment). After the network sends the RRC setup to the user equipment to establish the signaling connection at 520, at 530, the user equipment can send RRC setup complete to the network. In the RRC setup complete message, the user equipment can include the information for the configured grant requests list, up to N such instances, each with a specific period, repK repetition level, and resource request level K.

At 540, when the network sends the RRC reconfiguration message to the user equipment to set up the data radio bearers (DRBs), the network can include the configured grant allocation list, up to N instances that the user equipment requested. Each item of the list can include the requested period, repK, transmit parameters, and the list of resource allocation up to K levels, each with pre-configured time and frequency allocations. The network can pre-allocate the maximum K level that the user equipment requested. The grant-free allocations for all N instances can then be set up successfully. The user equipment can acknowledge with a radio resource control reconfiguration complete message at 550.

When the grant-free transmission is activated, the user equipment can start sending periodic data packets for each transmission opportunity, with varying data rates and different repetition levels. Thus, the UE can send with Configured Grant 1 at 562, with Configured Grant 2 at 564, with Configured Grant 3 at 566, and with Configured Grant 4 at 568. In this example, the configured grants correspond to those illustrated in FIGS. 3 and 4, simply by way of illustration. Other configured grants are also permitted.

As shown in FIG. 5, each of the application data packets can be sent in the physical uplink shared channel. In other communication systems, the same principle could be applied, in which case the name of the communication channels may be different.

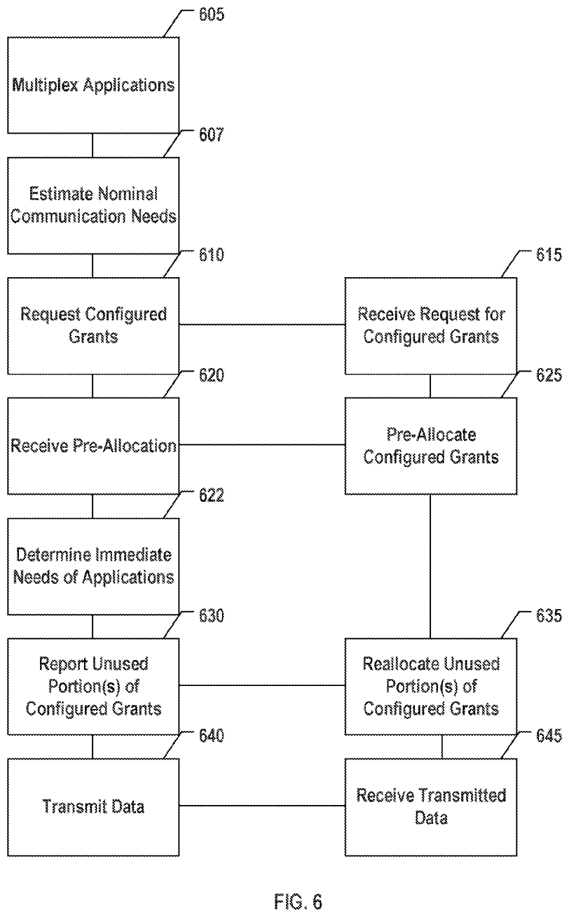

FIG. 6 illustrates a method according to certain embodiments of the present disclosure. The method of FIG. 6 may be implemented by, for example, a user equipment in communication with an access node or other base station. Thus, for example, the steps shown on the left side of FIG. 6 may be performed by a user equipment, while the steps shown on the right side of FIG. 6 may be performed by a base station or other network element. The method may be implemented in hardware, software, or a combination thereof.

As shown in FIG. 6, a method for grant-free uplink communication can include, at 610, requesting, by a user equipment, a plurality of instances of configured grants, each with at least one of a specific resource level, repetition, or period. In some cases, each instance of configured grant can specify the resource level, repetition, and period.

The method can also include, at 620, receiving, at the user equipment, a pre-allocation of the requested plurality of instances of the configured grants at the at least one of the specific resource level, repetition, or period. In other words, the pre-allocation may match the request. Optionally, the pre-allocation may only match a portion of the request, for example, if the network determines that there are not sufficient resources to grant all of the requests. As another alternative, if the request cannot be granted in full, the network may send a message indicating that the request is being denied.

The method can further include, at 640, transmitting, by the user equipment, data according to the pre-allocation. The transmitting of the data can include transmitting at varying data rates up to a level provided by the pre-allocation, depending on user equipment needs. FIG. 4 provides an example of varying data rates, in contrast to the consistent data rates shown in FIG. 3. Each instance of the plurality of instances of configured grants can be for a different logical channel or group of logical channels.

As shown in FIG. 6, the method can further include, at 605, multiplexing concurrent low latency applications with different traffic requirement needs from one another. In some embodiments, low latency can refer to latency below a threshold number of milliseconds. In some embodiments, the latency can be measured with reference to the time that a modem of the user equipment receives data packets from an application to the time that the modem transmits the data packets to an access point or other base station or network element. In other cases, low latency can refer to data that is to be transmitted as a URLLC communication. The multiplexing at 605 can be accomplished using the requesting at 610 and then subsequently transmitting the data at 640.

The requesting at 610 can include requesting a discrete resource allocation level for each of the plurality of instances of the configured grants. As mentioned above, there may be a finite integer number, M, of possible resource allocation levels such as, for example, eight resource allocation levels.

As shown in FIG. 6, the method can further include, at 607, estimating nominal communication needs for a plurality of applications, such as the amount and frequency of data to be transmitted by each application. Each requested discrete resource allocation level can be based on the estimated nominal communication needs of a respective application of the plurality of applications.

The method can further include, at 622, determining needs of applications. This determination can be made on an on-going basis as the implementing user equipment operates. Thus, these may be the immediate or short-term needs of the applications, as distinct from the long-term or maximum needs of the applications. The method can also include, at 630, reporting an unused portion of the pre-allocation based on the determined needs of the applications. This report can be included as a MAC CE, as explained above.

The requesting at 610 can be performed during connection setup in a radio resource control setup message, as illustrated in FIG. 5. Similarly, the receiving of the pre-allocation at 620 can involve receiving the pre-allocation in a radio resource control reconfiguration message.

The method of FIG. 6 can also include a corresponding method for control of grant-free uplink communication. The method can include, at 615, receiving a request from the user equipment for the plurality of instances of configured grants, each with at least one of a specific resource level, repetition, or period. The method can also include, at 625, pre-allocating to the user equipment the requested plurality of instances of the configured grants at the at least one of the specific resource level, repetition, or period. The method can further include, at 645, receiving subsequently transmitted data from the user equipment according to the pre-allocation.

The method can further include (not explicitly shown in FIG. 6) receiving, from the user equipment, the report of the unused portion of the pre-allocation sent at 630. The method can additionally include, at 635, reallocating the unused portion to another user equipment. The reallocation can be done using responses to scheduling requests by the other user equipment. The unused portion can be explicitly indicated in a MAC CE or can be implicitly indicated by the user equipment discontinuing the use of the resource for one repetition of a plurality of the repetitions.

The pre-allocating at 625 can be performed using a radio resource control reconfiguration message, as illustrated in FIG. 5.

Hence certain embodiments can allow the user equipment to adaptively transmit varying data rates for multiple concurrent low latency data applications with periodic traffic, in a grant-free scheme with no scheduling delay. This method may be used for URLLC applications.

Certain embodiments may provide a simple, practical scheme with minimal software complexity. Moreover, certain embodiments may eliminate grant servicing delays with known exact grant size for MACPDU preparation. Additionally, certain embodiments may eliminate scheduling delays with pre-configured resource levels. Furthermore, certain embodiments may provide improved user equipment power with reduced data rates when not needed. Additionally, certain embodiments may provide reduced interference levels to other UEs. Also, certain embodiments may also allow the network to re-allocate unused resources for other UEs.

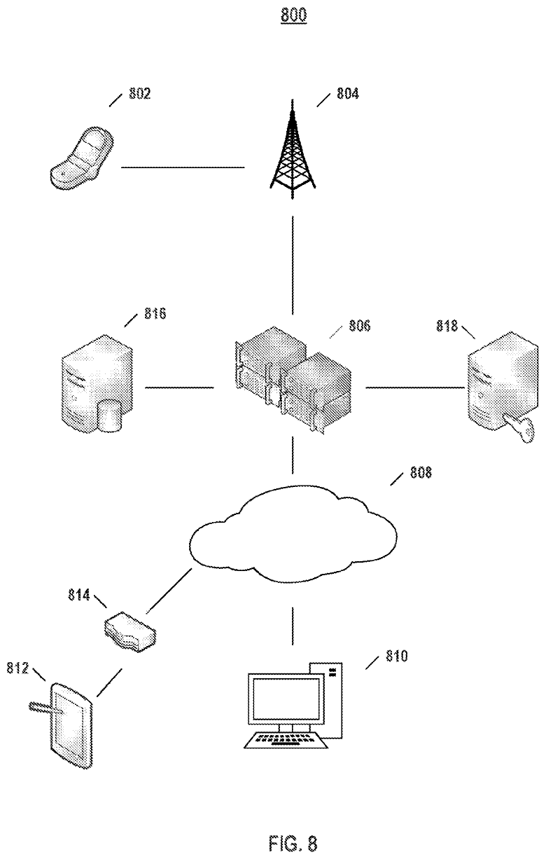

The software and hardware interworking systems disclosed herein, such as those implementing the signal flow of FIG. 5, the method of FIG. 6, or the timing examples of FIGS. 3 and 4, may be implemented by any suitable nodes in a wireless network. For example, FIG. 8 illustrates an exemplary wireless network 800, in which some aspects of the present disclosure may be implemented, according to some embodiments of the present disclosure.

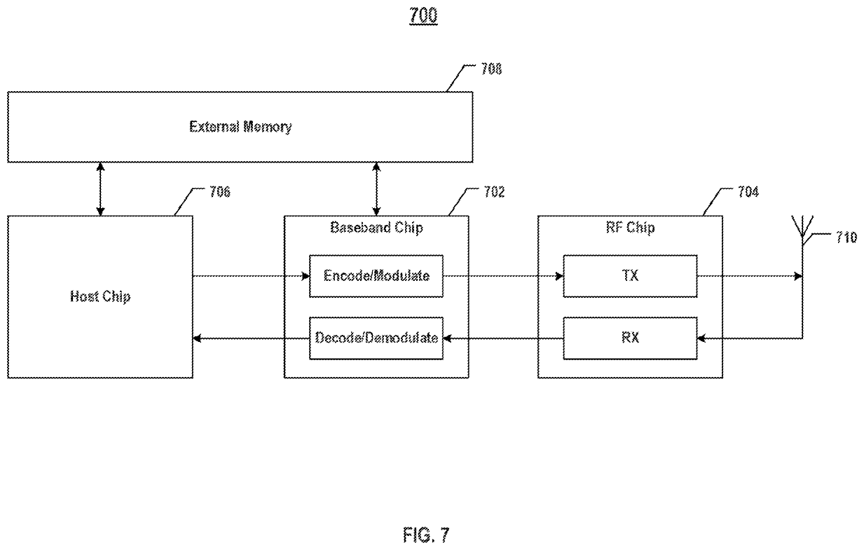

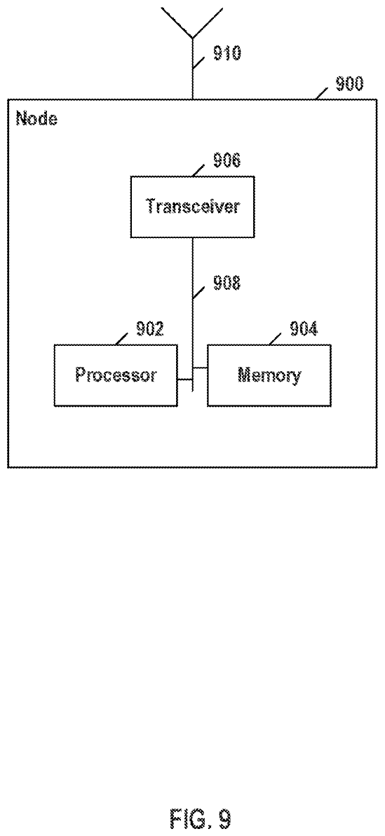

FIG. 7 illustrates a block diagram of an apparatus 700 including a baseband chip 702, an RF chip 704, and a host chip 706, according to some embodiments of the present disclosure. Apparatus 700 may be an example of any suitable node of wireless network 800 in FIG. 8, such as user equipment 802 or access node 804. As shown in FIG. 7, apparatus 700 may include baseband chip 702, RF chip 704, host chip 706, and one or more antennas 710. In some embodiments, baseband chip 702 is implemented by processor 902 and memory 904, and RF chip 704 is implemented by processor 902, memory 904, and transceiver 906, as described below with respect to FIG. 9. Besides the on-chip memory (also known as “internal memory,” e.g., registers, buffers, or caches) on each chip 702, 704, or 706, apparatus 700 may further include an external memory 708 (e.g., the system memory or main memory) that can be shared by each chip 702, 704, or 706 through the system/main bus. Although baseband chip 702 is illustrated as a standalone SoC in FIG. 7, it is understood that in one example, baseband chip 702 and RF chip 704 may be integrated as one SoC; in another example, baseband chip 702 and host chip 706 may be integrated as one SoC; in still another example, baseband chip 702, RF chip 704, and host chip 706 may be integrated as one SoC.

In the uplink, host chip 706 may generate raw data and send it to baseband chip 702 for encoding, modulation, and mapping. Baseband chip 702 may also access the raw data generated by host chip 706 and stored in external memory 708, for example, using the direct memory access (DMA). Baseband chip 702 may first encode (e.g., by source coding and/or channel coding) the raw data and modulate the coded data using any suitable modulation techniques, such as multi-phase pre-shared key (MPSK) modulation or quadrature amplitude modulation (QAM). Baseband chip 702 may perform any other functions, such as symbol or layer mapping, to convert the raw data into a signal that can be used to modulate the carrier frequency for transmission. In the uplink, baseband chip 702 may send the modulated signal to RF chip 704. RF chip 704, through the transmitter (Tx), may convert the modulated signal in the digital form into analog signals, i.e., RF signals, and perform any suitable front-end RF functions, such as filtering, up-conversion, or sample-rate conversion. Antenna 710 (e.g., an antenna array) may transmit the RF signals provided by the transmitter of RF chip 704.

In the downlink, antenna 710 may receive RF signals and pass the RF signals to the receiver (Rx) of RF chip 704. RF chip 704 may perform any suitable front-end RF functions, such as filtering, down-conversion, or sample-rate conversion, and convert the RF signals into low-frequency digital signals (baseband signals) that can be processed by baseband chip 702. In the downlink, baseband chip 702 may demodulate and decode the baseband signals to extract raw data that can be processed by host chip 706. Baseband chip 702 may perform additional functions, such as error checking, de-mapping, channel estimation, descrambling, etc. The raw data provided by baseband chip 702 may be sent to host chip 706 directly or stored in external memory 708.

As shown in FIG. 8, wireless network 800 may include a network of nodes, such as a UE 802, an access node 804, and a core network element 806. User equipment 802 may be any terminal device, such as a mobile phone, a desktop computer, a laptop computer, a tablet, a vehicle computer, a gaming console, a printer, a positioning device, a wearable electronic device, a smart sensor, or any other device capable of receiving, processing, and transmitting information, such as any member of a vehicle to everything (V2X) network, a cluster network, a smart grid node, or an Internet-of-Things (IoT) node. It is understood that user equipment 802 is illustrated as a mobile phone simply by way of illustration and not by way of limitation.

Access node 804 may be a device that communicates with user equipment 802, such as a wireless access point, a base station (BS), a Node B, an enhanced Node B (eNodeB or eNB), a next-generation NodeB (gNodeB or gNB), a cluster master node, or the like. Access node 804 may have a wired connection to user equipment 802, a wireless connection to user equipment 802, or any combination thereof. Access node 804 may be connected to user equipment 802 by multiple connections, and user equipment 802 may be connected to other access nodes in addition to access node 804. Access node 804 may also be connected to other UEs. It is understood that access node 804 is illustrated by a radio tower by way of illustration and not by way of limitation.

Core network element 806 may serve access node 804 and user equipment 802 to provide core network services. Examples of core network element 806 may include a home subscriber server (HSS), a mobility management entity (MME), a serving gateway (SGW), or a packet data network gateway (PGW). These are examples of core network elements of an evolved packet core (EPC) system, which is a core network for the LTE system. Other core network elements may be used in LTE and in other communication systems. In some embodiments, core network element 806 includes an access and mobility management function (AMF) device, a session management function (SMF) device, or a user plane function (UPF) device, of a core network for the NR system. It is understood that core network element 806 is shown as a set of rack-mounted servers by way of illustration and not by way of limitation.

Core network element 806 may connect with a large network, such as the Internet 808, or another IP network, to communicate packet data over any distance. In this way, data from user equipment 802 may be communicated to other UEs connected to other access points, including, for example, a computer 810 connected to Internet 808, for example, using a wired connection or a wireless connection, or to a tablet 812 wirelessly connected to Internet 808 via a router 814. Thus, computer 810 and tablet 812 provide additional examples of possible UEs, and router 814 provides an example of another possible access node.

A generic example of a rack-mounted server is provided as an illustration of core network element 806. However, there may be multiple elements in the core network including database servers, such as a database 816, and security and authentication servers, such as an authentication server 818. Database 816 may, for example, manage data related to user subscription to network services. A home location register (HLR) is an example of a standardized database of subscriber information for a cellular network. Likewise, authentication server 818 may handle authentication of users, sessions, and so on. In the NR system, an authentication server function (AUSF) device may be the specific entity to perform user equipment authentication. In some embodiments, a single server rack may handle multiple such functions, such that the connections between core network element 806, authentication server 818, and database 816, may be local connections within a single rack.

Although the above-description used uplink and downlink processing of a packet in a UE as examples in various discussions, similar techniques may likewise be used for the other direction of processing and for processing in other devices, such as access nodes, and core network nodes. For example, any device that processes packets according to a reconfigurable schedule may benefit some embodiments of the present disclosure, even if not specifically listed above or illustrated in the example network of FIG. 8.

Each of the elements of FIG. 8 may be considered a node of wireless network 800. More detail regarding the possible implementation of a node is provided by way of example in the description of a node 900 in FIG. 9 below. Node 900 may be configured as user equipment 802, access node 804, or core network element 806 in FIG. 8. Similarly, node 900 may also be configured as computer 810, router 814, tablet 812, database 816, or authentication server 818 in FIG. 8.

As shown in FIG. 9, node 900 may include a processor 902, a memory 904, a transceiver 906. These components are shown as connected to one another by bus 908, but other connection types are also permitted. When node 900 is user equipment 802, additional components may also be included, such as a user interface (UI), sensors, and the like. Similarly, node 900 may be implemented as a blade in a server system when node 900 is configured as core network element 806. Other implementations are also possible.

Transceiver 906 may include any suitable device for sending and/or receiving data. Node 900 may include one or more transceivers, although only one transceiver 906 is shown for simplicity of illustration. An antenna 910 is shown as a possible communication mechanism for node 900. Multiple antennas and/or arrays of antennas may be utilized. Additionally, examples of node 900 may communicate using wired techniques rather than (or in addition to) wireless techniques. For example, access node 804 may communicate wirelessly to user equipment 802 and may communicate by a wired connection (for example, by optical or coaxial cable) to core network element 806. Other communication hardware, such as a network interface card (NIC), may be included as well.

As shown in FIG. 9, node 900 may include processor 902. Although only one processor is shown, it is understood that multiple processors can be included. Processor 902 may include microprocessors, microcontrollers, digital signal processors (DSPs), application specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Processor 902 may be a hardware device having one or many processing cores. Processor 902 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software. Processor 902 may be a baseband chip, such as baseband chip 702 in FIG. 7. The node 900 may also include other processors, not shown, such as a central processing unit of the device, a graphics processor, or the like. The processor 902 may include internal memory (not shown in FIG. 9) that may serve as memory for L2 data. Processor 902 may include an RF chip, for example, integrated into a baseband chip, or an RF chip may be provided separately. Processor 902 may be configured to operate as a modem of node 900, or may be one element or component of a modem. Other arrangements and configurations are also permitted.

As shown in FIG. 9, node 900 may also include memory 904. Although only one memory is shown, it is understood that multiple memories can be included. Memory 904 can broadly include both memory and storage. For example, memory 904 may include random-access memory (RAM), read-only memory (ROM), SRAM, dynamic RAM (DRAM), ferro-electric RAM (FRAM), electrically erasable programmable ROM (EEPROM), CD-ROM or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 902. Broadly, memory 904 may be embodied by any computer-readable medium, such as a non-transitory computer-readable medium. The memory 904 can be the external memory 708 in FIG. 7. The memory 904 may be shared by processor 902 and other components of node 900, such as the unillustrated graphic processor or central processing unit.

In various aspects of the present disclosure, the functions described herein may be implemented in hardware, software, firmware, or any combination thereof. If implemented in software, the functions may be stored on or encoded as instructions or code on a non-transitory computer-readable medium. Computer-readable media includes computer storage media. Storage media may be any available media that can be accessed by a computing device, such as node 900 in FIG. 9. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, DVD, and floppy disk where disks usually reproduce data magnetically, while discs reproduce data optically with lasers. Combinations of the above should also be included within the scope of computer-readable media.

According to an aspect of the present disclosure, a method for grant-free uplink communication can include requesting, by a user equipment, a plurality of instances of configured grants, each with at least one of a specific resource level, repetition, or period. The method can also include receiving, at the user equipment, a pre-allocation of the requested plurality of instances of the configured grants at the at least one of the specific resource level, repetition, or period. The method can further include transmitting, by the user equipment, data according to the pre-allocation.

In some embodiments, the transmitting the data can include transmitting at varying data rates up to a level provided by the pre-allocation, depending on user equipment needs.

In some embodiments, each instance of the plurality of instances of configured grants can be for a different logical channel or group of logical channels.

In some embodiments, the method can further include multiplexing concurrent low latency applications with different traffic requirement needs.

In some embodiments, the requesting can include requesting a discrete resource allocation level for each of the plurality of instances of the configured grants.

In some embodiments, the method can further include estimating nominal communication needs for a plurality of applications. Each requested discrete resource allocation level can be based on the estimated nominal communication needs of a respective application of the plurality of applications.

In some embodiments, the method can further include determining needs of applications. The method can also include reporting an unused portion of the pre-allocation based on the determined needs of the applications.

In some embodiments, the requesting can be performed during connection setup in a radio resource control setup message.

In some embodiments, the receiving the pre-allocation comprises receiving the pre-allocation in a radio resource control reconfiguration message.

According to another aspect of the present disclosure, a method for control of grant-free uplink communication can include receiving a request from a user equipment for a plurality of instances of configured grants, each with at least one of a specific resource level, repetition, or period. The method can also include pre-allocating to the user equipment the requested plurality of instances of the configured grants at the at least one of the specific resource level, repetition, or period. The method can further include receiving subsequently transmitted data from the user equipment according to the pre-allocation.

In some embodiments, each instance of the plurality of instances of configured grants can be for a different logical channel or group of logical channels.

In some embodiments, the request can include a request for a discrete resource allocation level for each of the plurality of instances of the configured grants.

In some embodiments, the method can further include receiving, from the user equipment, a report of an unused portion of the pre-allocation. The method can additionally include reallocating the unused portion to another user equipment.

In some embodiments, the report can be received in a MAC CE.

In some embodiments, the pre-allocating can include sending the pre-allocation in a radio resource control reconfiguration message.

According to a further aspect of the present disclosure, an apparatus for grant-free uplink communication, such as user equipment, can include at least one processor and at least one memory having computer program instructions. The memory and the computer program instructions can be configured to, with the at least one processor, cause the apparatus at least to request a plurality of instances of configured grants, each with at least one of a specific resource level, repetition, or period. The memory and the computer program instructions can also be configured to, with the at least one processor, cause the apparatus at least to receive a pre-allocation of the requested plurality of instances of the configured grants at the at least one of the specific resource level, repetition, or period. The memory and the computer program instructions can also be configured to, with the at least one processor, cause the apparatus at least to transmit data according to the pre-allocation.

In some embodiments, the memory and the computer program instructions can be configured to, with the at least one processor, cause the apparatus at least to transmit the data at varying data rates up to a level provided by the pre-allocation, depending on user equipment needs.

In some embodiments, each instance of the plurality of instances of configured grants can be for a different logical channel or group of logical channels.

In some embodiments, the memory and the computer program instructions can be configured to, with the at least one processor, cause the apparatus at least to multiplex concurrent low latency applications with different traffic requirement needs.

In some embodiments, the memory and the computer program instructions can be configured to, with the at least one processor, cause the apparatus at least to request a discrete resource allocation level for each of the plurality of instances of the configured grants.

In some embodiments, the memory and the computer program instructions can be configured to, with the at least one processor, cause the apparatus at least to estimate nominal communication needs for a plurality of applications. Each requested discrete resource allocation level can be based on the estimated nominal communication needs of a respective application of the plurality of applications.

In some embodiments, the memory and the computer program instructions can be configured to, with the at least one processor, cause the apparatus at least to determine needs of applications. The memory and the computer program instructions can also be configured to, with the at least one processor, cause the apparatus at least to report an unused portion of the pre-allocation based on the determined needs of the applications.

In some embodiments, the memory and the computer program instructions can be configured to, with the at least one processor, cause the apparatus at least to perform the requesting during connection setup in a radio resource control setup message.

In some embodiments, the memory and the computer program instructions can be configured to, with the at least one processor, cause the apparatus at least to receive the pre-allocation in a radio resource control reconfiguration message.

According to yet another aspect of the present disclosure, an apparatus for control of grant-free uplink communication, such as a base station or access point, can include at least one processor and at least one memory having computer program instructions. The memory and the computer program instructions can be configured to, with the at least one processor, cause the apparatus at least to receive a request from a user equipment for a plurality of instances of configured grants, each with at least one of a specific resource level, repetition, or period. The memory and the computer program instructions can also be configured to, with the at least one processor, cause the apparatus at least to pre_allocate to the user equipment the requested plurality of instances of the configured grants at the at least one of the specific resource level, repetition, or period. The memory and the computer program instructions can further be configured to, with the at least one processor, cause the apparatus at least to receive subsequently transmitted data from the user equipment according to the pre-allocation.

In some embodiments, each instance of the plurality of instances of configured grants can be for a different logical channel or group of logical channels.

In some embodiments, the request can be a request for a discrete resource allocation level for each of the plurality of instances of the configured grants.

In some embodiments, the memory and the computer program instructions can be configured to, with the at least one processor, cause the apparatus at least to receive, from the user equipment, a report of an unused portion of the pre-allocation. The memory and the computer program instructions can also be configured to, with the at least one processor, cause the apparatus at least to reallocate the unused portion to another user equipment.

In some embodiments, the memory and the computer program instructions can be configured to, with the at least one processor, cause the apparatus at least to receive the report in a MAC CE.

In some embodiments, the memory and the computer program instructions can be configured to, with the at least one processor, cause the apparatus at least to send the pre-allocation in a radio resource control reconfiguration message.

According to still another aspect of the present disclosure, a non-transitory computer-readable medium can be encoded with instructions that, when executed in hardware, perform a method for grant-free uplink communication. The method can include requesting, by a user equipment, a plurality of instances of configured grants, each with at least one of a specific resource level, repetition, or period. The method can also include receiving, at the user equipment, a pre-allocation of the requested plurality of instances of the configured grants at the at least one of the specific resource level, repetition, or period. The method can additionally include transmitting, by the user equipment, data according to the pre-allocation.

According to a still further aspect of the present disclosure, a non-transitory computer-readable medium can be encoded with instructions that, when executed in hardware, perform a method for control of grant-free uplink communication. The method can include receiving a request from a user equipment for a plurality of instances of configured grants, each with at least one of a specific resource level, repetition, or period. The method can also include pre-allocating to the user equipment the requested plurality of instances of the configured grants at the at least one of the specific resource level, repetition, or period. The method can further include receiving subsequently transmitted data from the user equipment according to the pre-allocation.

The foregoing description of the specific embodiments will so reveal the general nature of the present disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The particular arrangements provided are illustrative and without limitation. Accordingly, the functional blocks, modules, and steps may be re-ordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

What is claimed is:

1. A method for grant-free uplink communication, comprising:
requesting, by a user equipment, a plurality of instances of configured grants, each with at least one of a specific resource level, repetition, or period;
receiving, at the user equipment, a pre-allocation of the requested plurality of instances of the configured grants at the at least one of the specific resource level, repetition, or period; and
transmitting, by the user equipment, data according to the pre-allocation.

2. The method of claim 1, wherein the transmitting the data comprises transmitting at varying data rates up to a level provided by the pre-allocation, depending on user equipment needs.

3. The method of claim 1, wherein each instance of the plurality of instances of configured grants is for a different logical channel or group of logical channels.

4. The method of claim 1, further comprising:
multiplexing concurrent low latency applications with different traffic requirement needs.

5. The method of claim 1, wherein the requesting comprises requesting a discrete resource allocation level for each of the plurality of instances of the configured grants.

6. An apparatus for grant-free uplink communication, comprising:
at least one processor; and
at least one memory comprising computer program instructions, wherein the at least one memory and the computer program instructions are configured to, with the at least one processor, cause the apparatus at least to:
request a plurality of instances of configured grants, each with at least one of a specific resource level, repetition, or period;
receive a pre-allocation of the requested plurality of instances of the configured grants at the at least one of the specific resource level, repetition, or period; and
transmit data according to the pre-allocation.

7. The apparatus of claim 6, the at least one memory and the computer program instructions are configured to, with the at least one processor, cause the apparatus at least to transmit the data at varying data rates up to a level provided by the pre-allocation, depending on user equipment needs.

8. The apparatus of claim 6, wherein each instance of the plurality of instances of configured grants is for a different logical channel or group of logical channels.

9. The apparatus of claim 6, the at least one memory and the computer program instructions are configured to, with the at least one processor, cause the apparatus at least to multiplex concurrent low latency applications with different traffic requirement needs.

10. The apparatus of claim 6, the at least one memory and the computer program instructions are configured to, with the at least one processor, cause the apparatus at least to request a discrete resource allocation level for each of the plurality of instances of the configured grants.

11. The apparatus of claim 10, the at least one memory and the computer program instructions are configured to, with the at least one processor, cause the apparatus at least to estimate nominal communication needs for a plurality of applications, wherein each requested discrete resource allocation level is based on the estimated nominal communication needs of a respective application of the plurality of applications.

12. The apparatus of claim 6, the at least one memory and the computer program instructions are configured to, with the at least one processor, cause the apparatus at least to:
determine needs of applications; and
report an unused portion of the pre-allocation based on the determined needs of the applications.

13. The apparatus of claim 6, the at least one memory and the computer program instructions are configured to, with the at least one processor, cause the apparatus at least to perform the requesting during connection setup in a radio resource control setup message.

14. The apparatus of claim 6, the at least one memory and the computer program instructions are configured to, with the at least one processor, cause the apparatus at least to receive the pre-allocation in a radio resource control reconfiguration message.

15. An apparatus for control of grant-free uplink communication, comprising:
at least one processor; and
at least one memory comprising computer program instructions, wherein the at least one memory and the computer program instructions are configured to, with the at least one processor, cause the apparatus at least to:
receive a request from a user equipment for a plurality of instances of configured grants, each with at least one of a specific resource level, repetition, or period;
pre-allocate to the user equipment the plurality of instances of the configured grants at the at least one of the specific resource level, repetition, or period; and
receive subsequently transmitted data from the user equipment according to the pre-allocation.

16. The apparatus of claim 15, wherein each instance of the plurality of instances of configured grants is for a different logical channel or group of logical channels.

17. The apparatus of claim 15, wherein the request comprises a request for a discrete resource allocation level for each of the plurality of instances of the configured grants.

18. The apparatus of claim 15, the at least one memory and the computer program instructions are configured to, with the at least one processor, cause the apparatus at least to:
receive, from the user equipment, a report of an unused portion of the pre-allocation; and
reallocate the unused portion to another user equipment.

19. The apparatus of claim 18, the at least one memory and the computer program instructions are configured to, with the at least one processor, cause the apparatus at least to receive the report in a medium access control (MAC) control element.

20. The apparatus of claim 15, the at least one memory and the computer program instructions are configured to, with the at least one processor, cause the apparatus at least to send the pre-allocation in a radio resource control reconfiguration message.
